(19) United States
(12) Patent Application Publication
(10) Pub. No.: US 2015/0154443 A1
(43) Pub. Date: Jun. 4, 2015

(54) ELECTRONIC DEVICE AND METHOD FOR PROCESSING HANDWRITTEN DOCUMENT

(71) Applicant: Kabushiki Kaisha Toshiba, Tokyo (JP)

(72) Inventors: Yasuhiro Ookawara, Kunitachi Tokyo (JP); Takehiro Ogawa, Hamura Tokyo (JP)

(21) Appl. No.: 14/615,379

(22) Filed: Feb. 5, 2015

Related U.S. Application Data
(63) Continuation of application No. PCT/JP2013/057707, filed on Mar. 18, 2013.

(51) Int. Cl. G06K 9/00; G06F 17/22; G06F 17/30; G06F 17/24

(52) U.S. Cl. CPC G06K 9/00436; G06F 17/242; G06F 17/2247; G06K 9/00416; G06F 17/30908

(57) ABSTRACT

According to one embodiment, an electronic device executes a process of saving, in a first file, stroke data corresponding to handwritten strokes input by a handwriting in a format having a hierarchical document structure described in a markup language. The electronic device executes a process of generating at least one of (i) a plurality of handwriting feature amounts corresponding to handwritten strokes or (ii) a plurality of character codes corresponding to handwritten strokes by acquiring the stroke data from the first file. At least one of (i) a handwriting feature amount corresponding to non-processed handwritten strokes or (ii) a character code corresponding to non-processed handwritten strokes is saved in a second file different from the first file.

### CROSS REFERENCE TO RELATED APPLICATIONS

This application is a Continuation Application of PCT Application No. PCT/JP2013/057707, filed Mar. 18, 2013, the entire contents of which are incorporated herein by reference.

### FIELD

Embodiments described herein relate generally to a technique for processing a handwritten document.

### BACKGROUND

Recently, various types of electronic devices, such as tablets, PDAs and smartphones, have been developed. Most of these electronic devices comprise a touchscreen display for facilitating an input operation by a user.

The user can instruct the electronic device to execute a function associated with a menu or an object displayed on the touchscreen display, by touching it using, for example, a finger.

However, most of the existing electronic devices with touchscreen displays are products directed to consumers who are in pursuit of operability for various types of media data, such as image data and music data, and may be sometimes unsuitable for use in business settings, such as a conference, business negotiation, and product development. Therefore, even now, paper notebooks are widely used in business.

A technique of searching for a handwritten document using text obtained by recognizing the handwritten document has also been developed recently.

However, little consideration has been given so far to a technique of generating information for the search of a handwritten document during creating or editing of the handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic device according to an embodiment.

FIG. 2 is an exemplary view showing cooperation between the electronic device of the embodiment and an external device.

FIG. 3 shows a handwritten document example handwritten on the touchscreen display of the electronic device of the embodiment.

FIG. 4 is an exemplary view for explaining the outline of handwritten-document data corresponding to the handwritten document of FIG. 3 and stored in a recording medium by the electronic device of the embodiment.

FIG. 5 is an exemplary block diagram showing the system configuration of the electronic device of the embodiment.

FIG. 6 shows a desk-top/drawer screen displayed by the electronic device of the embodiment.

FIG. 7 shows a desk-top screen displayed by the electronic device of the embodiment.

FIG. 8 shows a note-view screen displayed by the electronic device of the embodiment.

FIG. 9 shows a search key input dialog displayed by the electronic device of the embodiment.

FIG. 10 is an exemplary block diagram showing the functionality configuration of a handwritten-note application program executed by the electronic device of the embodiment.

FIG. 11 shows the data structure of a handwritten document managed by the electronic device of the embodiment.

FIG. 12 shows feature-amount data managed by the electronic device of the embodiment.

FIG. 13 shows character-string data managed by the electronic device of the embodiment.

FIG. 14 is an exemplary view for explaining the outline of handwriting searching executed by the electronic device of the embodiment.

FIG. 15 is a flowchart showing a procedure of saving stroke data, feature-amount data and character-string data, executed by the electronic device of the embodiment.

FIG. 16 is an exemplary flowchart showing a procedure of search processing executed by the electronic device of the embodiment.

### DETAILED DESCRIPTION

Various embodiments will be described hereinafter with reference to the accompanying drawings.

In general, according to one embodiment, an electronic device includes circuitry. The circuitry executes a process of saving, in a first file, stroke data corresponding to handwritten strokes input by a handwriting in a format having a hierarchical document structure described in a markup language. The circuitry executes a process of generating at least one of (i) a plurality of handwriting feature amounts corresponding to handwritten strokes or (ii) a plurality of character codes corresponding to handwritten strokes by acquiring the stroke data from the first file. At least one of (i) a handwriting feature amount corresponding to non-processed handwritten strokes or (ii) a character code corresponding to non-processed handwritten strokes is saved in a second file different from the first file.

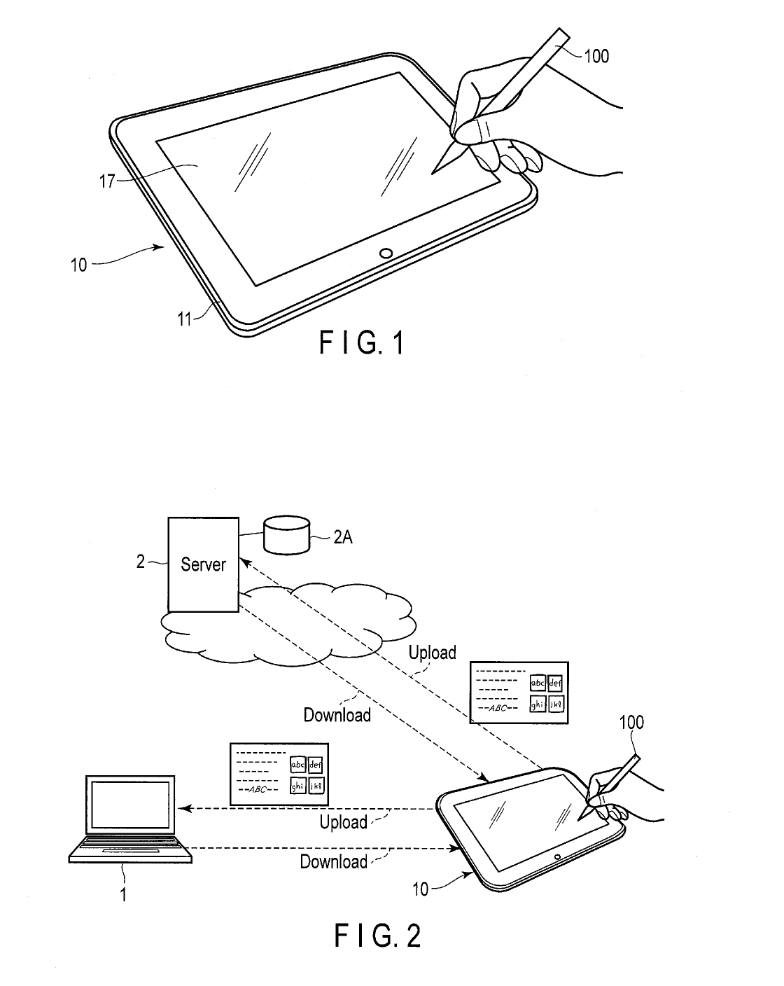

FIG. 1 is a perspective view showing the appearance of an electronic device according to an embodiment. This electronic device is a stylus-based portable electronic device that which enables handwriting input by a stylus or a finger. The electronic device can be realized as a tablet computer, a notebook computer (PC), a smartphone, a PDA, etc. In the description below, it is assumed that the electronic device is realized as a tablet computer 10. The tablet computer 10 is a portable electronic device called a tablet or a slate computer. The tablet computer 10 comprises a main body 11 and a touchscreen display 17 as shown in FIG. 1. The touchscreen display 17 is attached to the main body 11, superposed on the upper surface thereof.

The main body 11 has a thin box-shaped housing. The touchscreen display 17 incorporates a flat panel display, and a sensor configured to detect the contact position of a stylus or a finger on the screen of the flat panel display. The flat panel display may be a liquid crystal display (LCD) device. The sensor may be an electrostatic capacitive touch panel or an electromagnetic induction type digitizer. In the description below, it is assumed that the touchscreen display 17 incorporates two types of sensors, i.e., the digitizer and the touch panel.

The touchscreen display 17 can detect not only a touch operation on the screen using a finger, but also a touch operation on the screen using a stylus 100. The stylus 100 is, for example, an electromagnetic induction stylus. The user can perform a handwriting input operation on the touchscreen display 17, using an external object (stylus 100 or finger). During a handwriting input operation, the locus of the movement of the external object (stylus 100 or finger) on the screen, i.e., strokes (the locus of handwritten strokes) input by the handwriting input operation, are drawn in real time. Thus, plural strokes input by handwriting are displayed on the screen. The locus of the movement of the external object during the time when the external object is kept in contact with the screen corresponds to one stroke. A set of a large number of strokes corresponding to handwritten characters and objects (handwritten figures, characters, handwritten tables, etc.) other than the characters constitute a handwritten document.

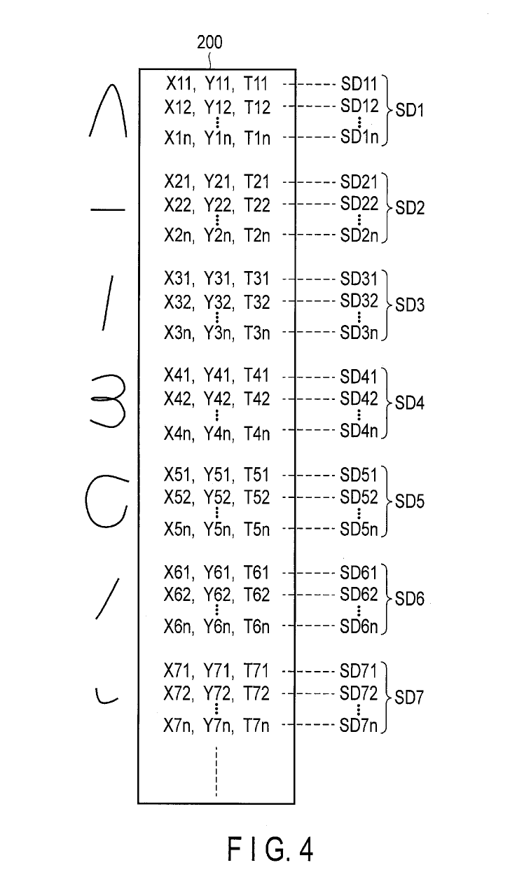

In the embodiment, the handwritten document is stored in a storage medium not in the form of image data but in the form of time-series data (handwritten-document data) that is indicative of a series of coordinates of the locus of each stroke and indicative of the order relation between strokes. The time-series data includes a plurality of stroke data corresponding to respective strokes. The handwritten-document data, an example of which will be described later with reference to FIG. 4, is indicative of the order of handwriting of a plurality of strokes, and includes a plurality of stroke data corresponding to the plurality of strokes. In other words, the handwritten-document data means a set of stroke data arranged in a time-series manner and corresponding to the plurality of strokes. Each stroke data corresponds to one stroke, and includes coordinate data series (time-series coordinates) corresponding to respective points of the one stroke. The order of arrangement of the plural stroke data corresponds to the order of handwriting of the strokes.

The tablet computer 10 can read arbitrary existing time-series data (handwritten-document data) from the storage medium, and draw (display), on the screen, the loci of a plurality of strokes indicated by the handwritten-document data. The plurality of strokes indicated by the handwritten-document data also correspond to a plurality of strokes input by handwriting.

Further, the tablet computer 10 has an editing function. The editing function enables an arbitrary portion (a handwritten character, a handwritten mark, a handwritten figure, a handwritten table, etc.) within a displayed handwritten document selected by a range selection tool to be erased or moved in accordance with a user's editing operation using an “eraser” tool, the range selection tool and other various tools. Yet further, an arbitrary portion within a handwritten document selected by the range selection tool can be designated as a search key for searching for the handwritten document.

In the embodiment, a handwritten document can be managed as a single page or a plurality of pages. In this case, by dividing handwritten-document data per unit area corresponding to the area of the screen, a piece of handwritten-document data fit into the screen may be recorded as one page. Alternatively, page size may be set variable. In this case, since the page size can be increased to an area greater than the screen size, a handwritten document greater than the screen size can be treated as one page. If the entire page cannot simultaneously be displayed on the display, the page may be shrunk, or its display target portion may be scrolled by vertical and horizontal scrolling.

FIG. 2 shows cooperation between the tablet computer 10 and an external device. The tablet computer 10 can cooperate with the personal computer 1 or a cloud. Namely, the tablet computer 10 comprises a wireless communication device, such as a wireless LAN, and can communicate with the personal computer 1 by radio. The tablet computer 10 can also communicate with a server 2 on the Internet. The server 2 may be a server that provides online storage service and other various types of cloud computing service.

The personal computer 1 comprises a storage device, such as a hard disk drive (HDD). The tablet computer 10 can transmit handwritten-document data to the personal computer 1 via a network, and store it in the HDD of the personal computer 1 (upload). To secure communication between the tablet computer 10 and the personal computer 1, the personal computer 1 may authenticate the tablet computer 10 at the start of communication. In this case, a dialog for encouraging a user to input ID or a password may be displayed on the screen of the tablet computer 10, or the ID, for example, of the tablet computer 10 may be automatically transmitted from the tablet computer 10 to the personal computer 1.

As a result, even when the storage capacity in the tablet computer 10 is small, the tablet computer 10 can process a large amount of handwritten-document data or large-capacity handwritten data.

Further, the tablet computer 10 can read one or more arbitrary handwritten-document data items from the HDD of the personal computer 1 (download), and can display, on the screen of the display 17, strokes corresponding to the read handwritten-document data items. At this time, a list of thumbnails obtained by scaling down the pages of a plurality of handwritten-document data items may be displayed on the screen of the display 17, or one page selected from the thumbnails may be displayed in a normal size on the screen of the display 17.

Yet further, as mentioned above, the tablet computer 10 may communicate with the server 2 on the cloud, which provides, for example, storage service, instead of the personal computer 1. The tablet computer 10 can transmit handwritten-document data to the server 2 via a network, and store it in a storage device 2A incorporated in the server 2 (upload). Further, the tablet computer 10 can read arbitrary handwritten-document data from the storage device 2A of the server 2 (download). The tablet computer 10 can display, on the screen of the touchscreen panel 17, the respective loci of the strokes corresponding to the read handwritten-document data.

As described above, in the embodiment, the storage medium for storing handwritten-document data may be any one of the storage devices in the tablet computer 10, the personal computer 1 and the server 2.

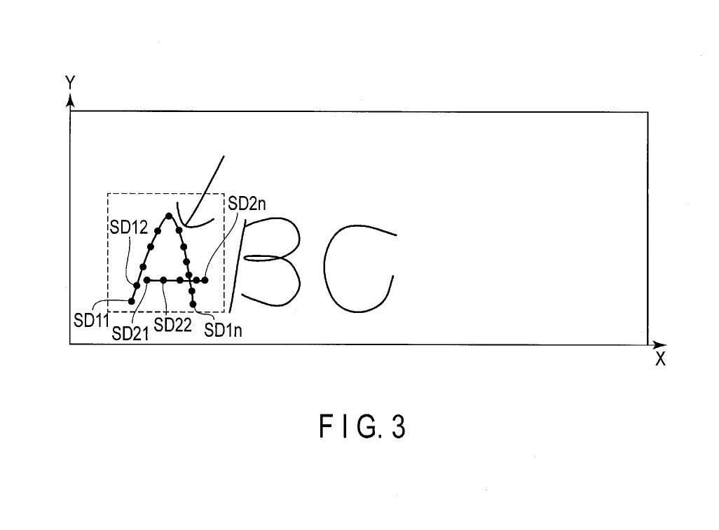

Referring then to FIGS. 3 and 4, a description will be given of the relationship between strokes (a character, a figure, a table, etc.) handwritten by the user and handwritten-document data. FIG. 3 shows an example of a handwritten document (handwritten character string) handwritten on the touchscreen display 17 using, for example, the stylus 100.

In a handwritten document, a character or figure may often be handwritten on an already handwritten character or figure. In the case of FIG. 3, it is assumed that a character string “ABC” is handwritten in the order of “A,” “B” and “C,” and thereafter an arrow is handwritten close to the handwritten character “A.”

The handwritten character “A” is expressed by two strokes (i.e., a locus in the form of “ [symbol] ” and a locus in the form of “−”), i.e., two loci, handwritten using, for example, the stylus 100. The locus, in the form of “ [symbol] ,” of the first stroke handwritten by the stylus 100 is sampled in real time at, for example, regular intervals, whereby time-series coordinates SD11, SD12, . . . , SD1n corresponding to the stroke “ [symbol] ” are obtained. Similarly, the locus, in the form of “−,” of a subsequent stroke handwritten by the stylus 100 is also sampled in real time at regular intervals, whereby time-series coordinates SD21, SD22, . . . , SD2n corresponding to the stroke “−” are obtained.

The handwritten character “B” is expressed by two strokes handwritten using, for example, the stylus 100, i.e., two loci. The handwritten character “C” is expressed by one stroke handwritten using, for example, the stylus 100, i.e., one locus. The handwritten “arrow” is expressed by two strokes handwritten using, for example, the stylus 100, i.e., two loci.

FIG. 4 shows handwritten-document data 200 corresponding to the handwritten document of FIG. 3. The handwritten-document data 200 includes a plurality of stroke data items SD1, SD2, . . . , SD7. In the handwritten-document data 200, stroke data items SD1, SD2, . . . , SD7 are arranged in the order of handwriting, i.e., in the time-series order in which the strokes were handwritten.

In the handwritten-document data 200, two lead stroke data items SD1 and SD2 are indicative of the two strokes of the handwritten character “A.” Third and fourth stroke data items SD3 and SD4 are indicative of the two strokes of the handwritten character “B.” Fifth stroke data item SD5 is indicative of the one stroke of the handwritten character “C.” Sixth and seventh stroke data items SD6 and SD7 are indicative of the respective two strokes of the handwritten “arrow.”

Each stroke data item includes coordinate data sequences (time-series coordinates) corresponding to one stroke, i.e., pairs of coordinates corresponding to the respective points on the locus of one stroke. In each stroke data item, pairs of coordinates are arranged in the order in which the points of a corresponding stroke were handwritten. For instance, regarding the handwritten character “A,” stroke data SD1 includes a coordinate data sequence (time-series coordinates) corresponding to points on the stroke “ [symbol] ” in the handwritten character “A,” i.e., n coordinate data items SD11, SD12, . . . , SD1n. Similarly, stroke data SD2 includes a coordinate data sequence corresponding to points on the stroke “−” in the handwritten character “A,” i.e., n coordinate data items SD21, SD22, . . . , SD2n. The stroke data items may include different numbers of coordinate data items.

Each coordinate data item comprises an X coordinate and a Y coordinate indicative of a corresponding point on a stroke. For instance, coordinate data item SD11 comprises the X coordinate (X11) and the Y coordinate (Y11) of the start point of the stroke “ [symbol] .” Coordinate data item SDln comprises the X coordinate (X1n) and the Y coordinate (Y1n1) of the end point of the stroke “ [symbol] .”

Further, a respective coordinate data item may include timestamp data T (time data) corresponding to a time at which a point indicated by the coordinate data item was handwritten. The point-handwritten time may be an absolute time (e.g., year, month, day, hour, second) or a relative time with respect to a certain reference time. For instance, an absolute time (e.g., year, month, day, hour, second) when writing of a stroke has started may be added to a respective stroke data item as timestamp data (time data) T, and further a relative time indicative of a difference from the absolute time may be added to the respective stroke data item as the timestamp data (time data) T. A relative time (time data) corresponding to certain coordinate data is equal to the time interval between the time when a stroke is started to be written, and the time when a point corresponding to the coordinate data has been handwritten.

Thus, the temporal relationship between strokes can be more accurately expressed using handwritten-document data that includes timestamp data T added to each stroke data.

In addition, data (Z) indicative of writing pressure may be added to each coordinate data item.

The handwritten-document data 200 having a structure as described with reference to FIG. 4 can express not only an individual stroke but also the temporal relationship between strokes. Accordingly, the use of the handwritten-document data 200 enables the tip of the handwritten “arrow” to be treated as a character or a figure different from the handwritten character “A,” even when the tip of the handwritten “arrow” is written overlapping with the character “A,” or close to the handwritten character “A.”

Further, in the embodiment, since as described above, the handwritten-document data is stored not as an image or a character recognition result, but as a set of time-series stroke data, each handwritten character can be treated regardless of the language of the handwritten character. Consequently, the structure of the handwritten-document data 200 of the embodiment can be shared between a variety of countries using different languages.

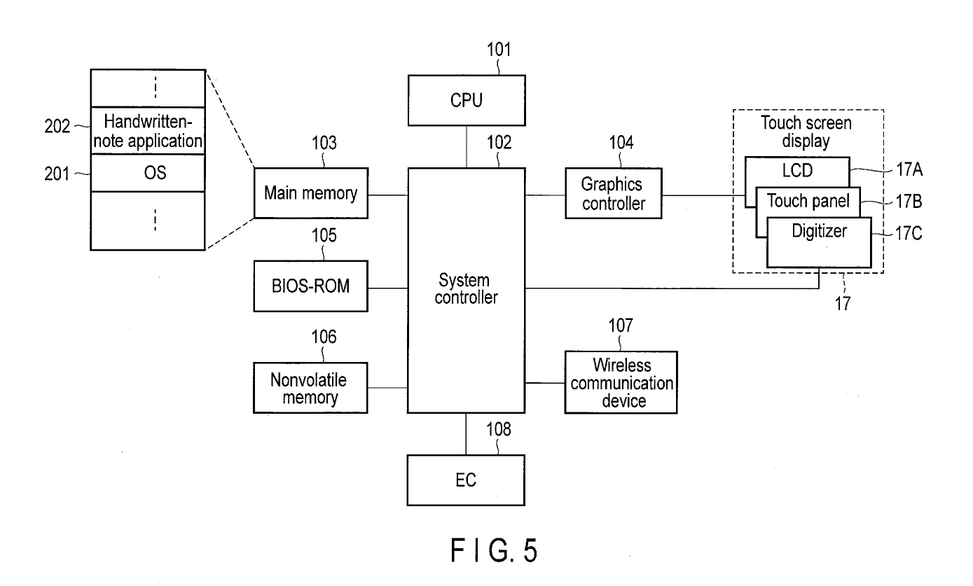

FIG. 5 shows a configuration example of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor configured to control the operations of various components in the tablet computer 10. The CPU 101 includes circuitry (processing circuitry). The CPU 101 executes various types of software loaded from the nonvolatile memory 106 to the main memory 103. The software includes an operating system (OS) 201 and various application programs. The application programs include a handwritten-note application program 202. The handwritten-note application program 202 has a function of creating and displaying the above-described handwritten-document data, a function of editing handwritten-document data, and a handwritten-document search function of searching for handwritten-document data including a desired handwritten portion, or a desired handwritten portion within certain handwritten-document data. The handwritten-document search function can execute both a handwriting search and a text search (character-string search). The handwriting search is a search method for searching for stroke data having a handwriting feature amount similar to the handwriting feature amount of handwritten strokes as a search key. The text search (character-string search) is a search method for searching for a handwritten character (stroke data group) corresponding to certain text (character code) as a search key.

The handwritten-document search function further includes a function of generating index data for searching for handwritten-document data. In the embodiment, the feature amount data and the character-string data are generated as index data. The feature amount data includes the handwriting feature amount of each stroke data item of each handwritten-document data item, and is used as index data for searching for a handwritten document using the above-mentioned handwriting search method. The character-string data includes a character code corresponding to each handwritten character in the handwritten-document data, and is used as index data for searching for a handwritten document using the above-mentioned text search method.

The CPU 101 also executes a basic input output system (BIOS) stored in the BIOS-ROM 105. The BIOS is a program for hardware control.

The system controller 102 is a device that connects the local bus of the CPU 101 to each component. The system controller 102 also contains a memory controller for performing access control of the main memory 103. The system controller 102 also has a function of communicating with the graphics controller 104 via a serial bus conforming to the PCI EXPRESS standard.

The graphics controller 104 is a display controller for controlling LCD 17A used as the display monitor of the tablet computer 10. The graphics controller 104 is configured to display (draw) on the screen of LCD 17A a plurality of loci corresponding to a plurality of handwritten strokes. The display signals generated by the graphics controller 104 are sent to LCD 17A. LCD 17A displays screen images based on the display signals. On LCD 17A, touch panel 17B and digitizer 17C are provided. Touch panel 17B is an electromagnetic capacitive sensor for enabling inputs on the screen of LCD 17A. The contact position of a finger on the screen and the movement of the contact position of the finger, for example, are detected by touch panel 17B. Digitizer 17C is an electromagnetic induction type sensor for enabling inputs on the screen of LCD 17A. The contact position of the stylus 100 on the screen and the movement of the contact position of the stylus, for example, are detected by digitizer 17C.

The wireless communication device 107 is configured to execute wireless communication, such as a wireless LAN or 3G mobile communication. The EC 108 is a single-chip microcomputer including an embedded controller for power management. The EC 108 has a function of turning on and off the tablet computer 10 in accordance with a user's operation of a power button.

A description will now be given of some typical examples of screens presented to a user by the handwritten-note application program 202.

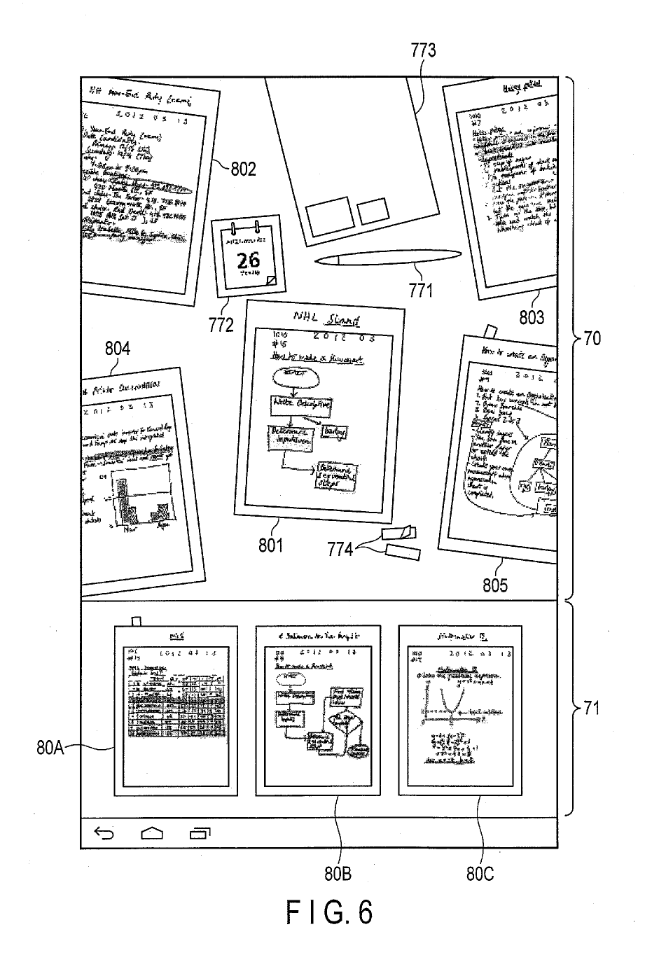

FIG. 6 shows a desktop/drawer screen displayed by the handwritten-note application program 202. The desktop/drawer screen is a basic screen for processing a plurality of handwritten-document data items. The handwritten-document data items will hereinafter be referred to as handwritten notes.

The desktop/drawer screen includes a desktop screen area 70 and a drawer screen area 71. The desktop screen area 70 is a temporary area for displaying a plurality of note icons 801 to 805 corresponding to a plurality of handwritten notes during working. The note icons 801 to 805 display thumbnails of certain pages of respective handwritten notes. The desktop screen area 70 further displays a stylus icon 771, a calendar icon 772, a scrap-note icon 773 and tag icons 774.

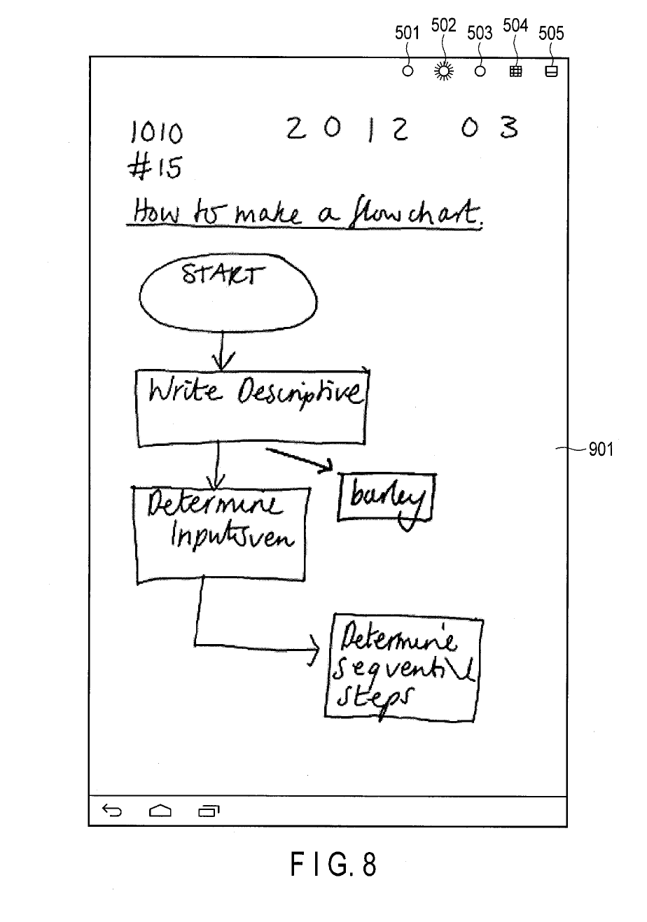

The stylus icon 771 is a graphical user interface (GUI) for switching the display screen from the desktop/drawer screen to a note-view screen described later referring to FIG. 8. The calendar icon 772 is an icon indicative of a current date. The calendar icon 772 is a GUI for switching the display screen from the desktop/drawer screen to a time-line note screen associated with the current date. The scrap-note icon 773 is a GUI for generating or browsing scrap data. The generated scrap data is registered in a scrapbook. The scrap-note icon 773 displays the thumbnail of each scrap data item. The tag icon 774 is a GUI for attaching a tag to an arbitrary page in an arbitrary handwritten note.

The drawer screen area 71 is a display area for browsing a storage area used to store all generated handwritten notes. The drawer screen area 71 displays note icons 80A, 80B and 80C corresponding to some handwritten notes included in all handwritten notes. Note icons 80A, 80B and 80C display thumbnails of certain pages of respective handwritten notes. The handwritten-note application program 202 can detect a gesture (for example, a swipe gesture) on the drawer screen area 71, which is made by a user using an external object. In response to the detection of the gesture (for example, the swipe gesture), the handwritten-note application program 202 leftward or rightward scrolls screen images on the drawer screen area 71. As a result, note icons corresponding to arbitrary handwritten notes can be displayed on the drawer screen area 71.

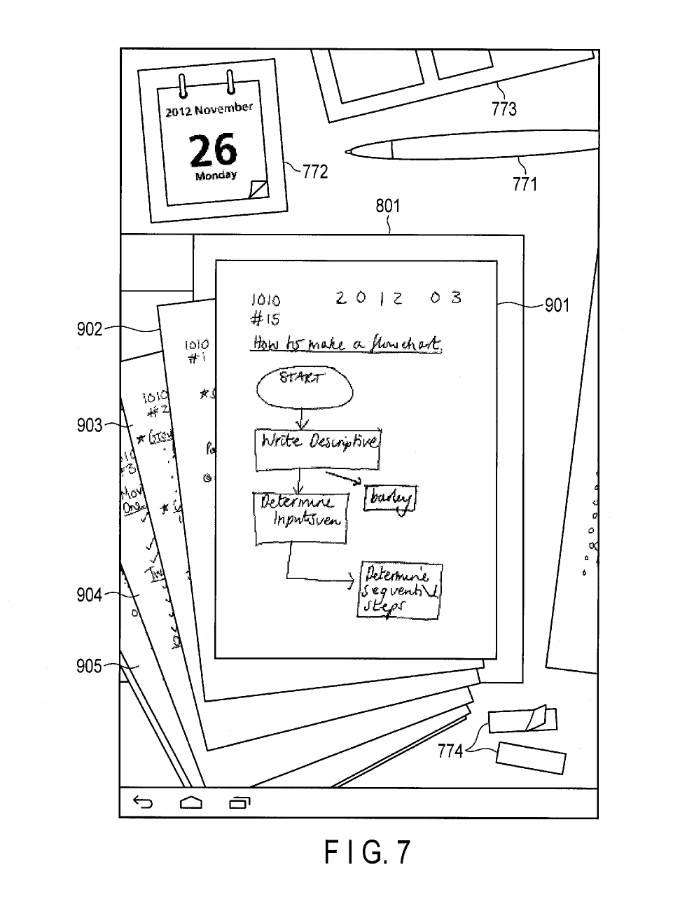

The handwritten-note application program 202 can also detect a gesture (for example, a tap gesture) on the drawer screen area 71, which is made by a user using an external object. In response to the detection of the gesture (for example, the tap gesture) on a certain note icon on the drawer screen area 71, the handwritten-note application program 202 moves the note icon to the center of the desktop screen area 70, and selects a handwritten note corresponding to the note icon, thereby displaying a desktop screen shown in FIG. 7 in place of the desktop/drawer screen. The desktop screen shown in FIG. 7 is a screen that enables an arbitrary page in the selected handwritten note to be browsed.

FIG. 7 shows the above-mentioned desktop screen.

This desktop screen enables an arbitrary page in the selected handwritten note to be browsed. It is assumed here that a handwritten note corresponding to the note icon 801 has been selected. In this case, the handwritten-note application program 202 displays a plurality of pages 901, 902, 903, 904 and 905 included in the handwritten note so that the pages 901, 902, 903, 904 and 905 overlap each other and at least parts of them can be viewed.

The desktop screen also displays the above-mentioned stylus icon 771, calendar icon 772, scrap-note icon 773 and tag icons 774.

The handwritten-note application program 202 can detect various gestures made by the user on the desktop screen. For instance, in response to detection of a certain gesture, the handwritten-note application program 202 changes, to a desired page, a page to be displayed in the uppermost position (page feed, page return). Further, in response to detection of a certain gesture (for example, a tap gesture) made on an uppermost page, or in response to detection of a certain gesture (for example, a tap gesture) made on the stylus icon 771, the handwritten-note application program 202 selects the uppermost page, and displays a note-view screen shown in FIG. 8 in place of the desktop screen.

The note-view screen of FIG. 8 enables a new page (handwritten page) to be created, and enables an existing page to be browsed and edited. When the page 901 has been selected from the desktop screen of FIG. 7, the note-view screen displays the content of the page 901 as shown in FIG. 8.

The note-view screen further displays a black-pen button 501, a red-pen button 502, a marker button 503, a selection button 504 and an erasure button 505.

For instance, if a handwriting input operation using the stylus 100 is executed on the note-view screen with the black-pen button 501 selected by a user's tap gesture, the handwritten-note application program 202 displays a black stroke (locus) on the note-view screen in accordance with the movement of the stylus 100.

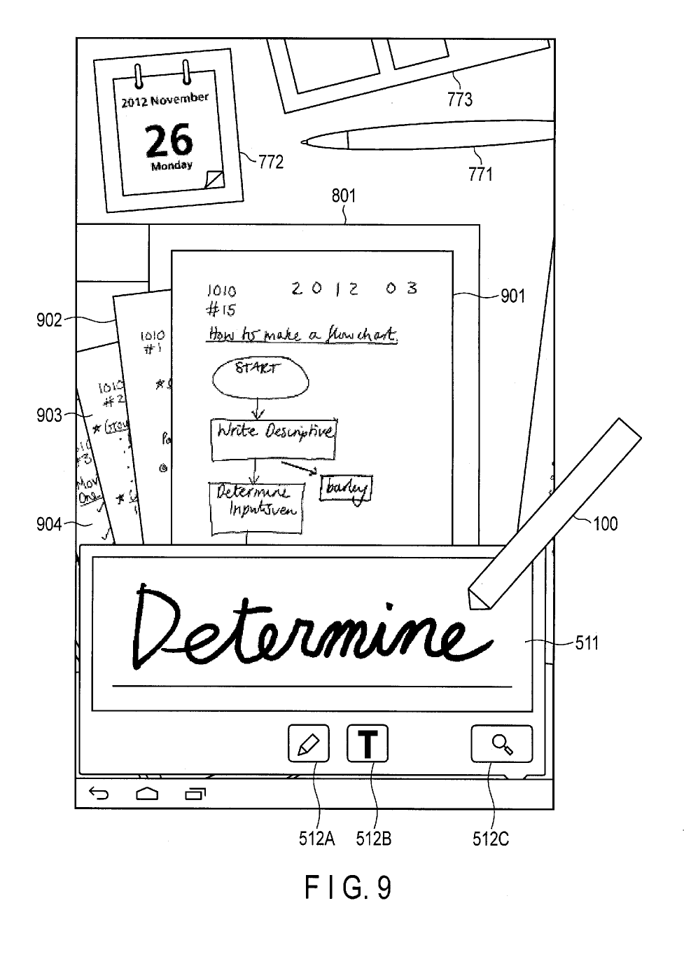

FIG. 9 shows an example of a search-key input dialog. For instance, in response to detection of a tap gesture made in an empty area on the desktop screen, the handwritten-note application program 202 displays, on the desktop screen, a search-key input dialog including search-key input area 511, handwriting search button 512A, text search button 512B and search execution button 512C. Handwriting search button 512A is used for selecting the above-mentioned handwriting search method. Text search button 512B is used for selecting the above-mentioned text search method. Search execution button 512C is used for requesting execution of search processing.

When the handwriting search method has been selected, the search-key input area 511 can be used as an input area for handwriting a character string, a figure, a table, etc., used as a search key. The user can handwrite not only a handwritten character string, but also a handwritten figure or table in the search-key input area 511. FIG. 9 shows an example case where a handwritten character string “Determine” is input as the search key in the search-key input area 511. When the user has selected the search button 512C, with the handwritten character string “Determine” input as the search key in the search-key input area 511, a handwriting search is executed to search for a handwritten document including stroke data group having a handwriting feature similar to that of the handwritten character string “Determine.”

When the text search method has been selected, a software keyboard, for example, is displayed on the screen. At this time, the user can input arbitrary text (character string) as the search key in the search-key input area 511 by operating the software keyboard. When the user has selected the search button 512C, with the text input as the search key in the search-key input area 511, a text search is executed to search for a handwritten document including stroke data group corresponding to the text.

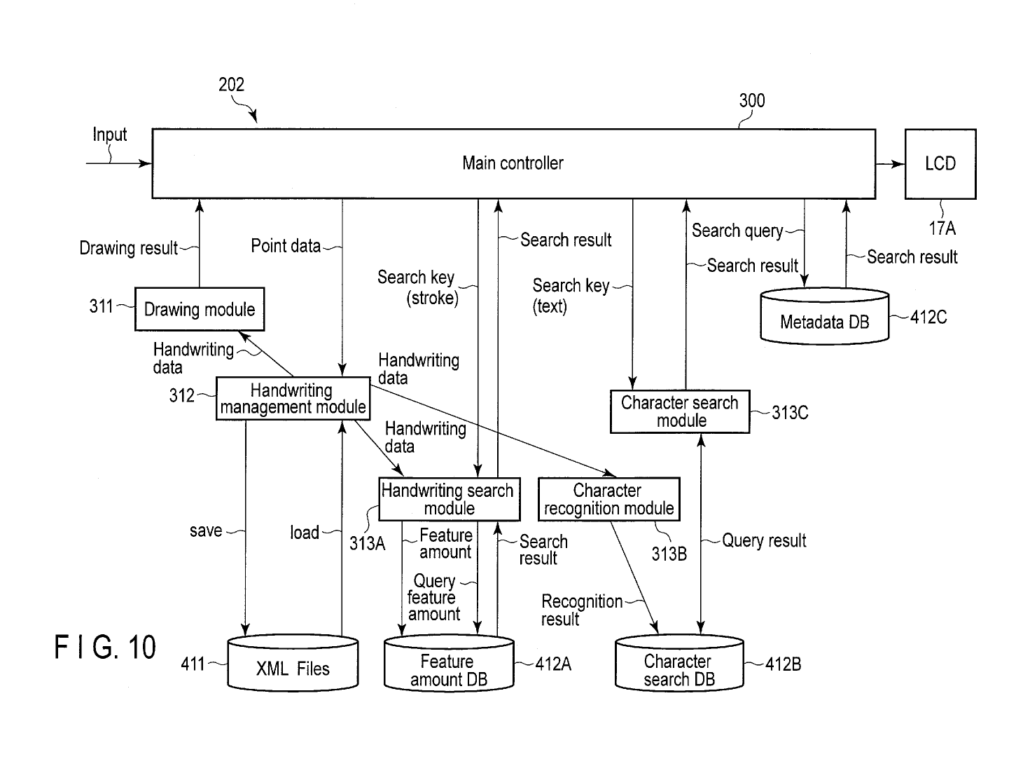

Referring then to FIG. 10, the functionality configuration of the handwritten-note application program 202 will be described.

The handwritten-note application program 202 is a WYSIWYG application that can process handwritten-document data, and comprises a main controller 300, a drawing module 311, a handwriting management module 312, handwriting search module 313A, character recognition module 313B and character search module 313C. The main controller 300 cooperates with, for example, the drawing module 311, handwriting management module 312, handwriting search module 313A, character recognition module 313B and character search module 313C to generate, display, edit, search for, etc., a handwritten document (handwritten page).

In the embodiment, the handwritten-document data (a plurality of stroke data items) and a set of handwriting-feature-amount data and character-string data are managed using different files. The handwritten-document data is managed using a file format corresponding to the markup language. For instance, as the file format corresponding to the markup language, an Extensible Markup Language (XML) file is usable. In this case, the handwritten-note application program 202 saves, in a first file (e.g., XML file), stroke data corresponding to handwritten strokes input by a handwriting in a format having a hierarchical document structure described in a markup language (e.g., XML). That is, stroke data corresponding to handwritten strokes input by handwriting (a plurality of stroke data items in the handwritten-document data) is saved (stored) in the first file (XML file). For instance, one handwritten page (handwritten-page data) may be managed using a single XML file. In this case, XML files corresponding to the number of handwritten pages are created.

Handwriting-feature-amount data and character-string data, which correspond to the handwritten page data, are saved (stored) in a second file, such as a database file, which differs from the XML file storing the stroke data items corresponding to the handwritten-page data. More specifically, the handwriting-feature-amount data and the character-string data are saved (stored) in the second file, such as the database file, (in, for example, a table form) in a state where a handwriting feature amount and a character code corresponding to one or more stroke data items are associated with identification data corresponding to the one or more stroke data items.

If the handwritten-page data (stroke data) and the set of the handwriting-feature-amount data and the character-string data corresponding to the handwritten-page data are managed using the same database, storage/updating of the stroke data or drawing processing of the stroke data may be unable to be executed while storage or updating of the handwriting-feature-amount data and the character-string data is being executed. This is because two different types of write processing cannot simultaneously be executed using a single database, although two different types of read processing can simultaneously be executed using the database. To secure data consistency, exclusive control must be executed in association with the different types of write processing. Even when the handwritten-page data (stroke data) and the set of the handwriting-feature-amount data and the character-string data are managed using different tables, similar exclusive control is needed as long as the tables are included in the same database file.

Drawing itself of a handwritten stroke may be executed before stroke data corresponding to the stroke is saved in a database. However, if the supply of power to the electronic device is interrupted before the stroke data is saved in the database, the stroke data corresponding to the stroke will be lost, although the stroke is drawn and presented to the user. Therefore, while the handwriting-feature-amount data and the character-string data in the database are being updated, it is necessary to stop not only saving/updating of stroke data, but also execution of the drawing processing, as is described above.

During creation of a handwritten page, handwriting-feature-amount data and character-string data, which correspond to the handwritten page, may not be generated. In this case, however, since handwriting-feature-amount data and character-string data, which correspond to the handwritten page, do not exist, it is possible that the currently-created handwritten page will not be searched for at all.

In the embodiment, handwritten-page data (stroke data) is saved in an XML file, and handwriting-feature-amount data and character-string data, which correspond to this handwritten page, are saved in another file (database file). Accordingly, when handwriting-feature-amount data and character-string data, which correspond to certain handwritten-page data, are now being saved in the database file, new stroke data can be added to the handwritten page data and a stroke corresponding to the new stroke data can be drawn (displayed) at once even before the saving of the handwriting-feature-amount data and the character-string data is finished. In other words, while handwritten-page data is being created or edited, handwriting-feature-amount data and character-string data, which correspond to the handwritten page, can be generated or saved substantially simultaneously with the creation/editing. For instance, when a new stroke is handwritten, the locus of this stroke is drawn (displayed) and stroke data corresponding to the stroke is saved in the XML file at once. The stroke data is read from the XML file, and handwriting-feature-amount data and character-string data, which correspond to the stroke data, are generated. The thus-generated handwriting-feature-amount data and character-string data are saved in another file, such as a database file.

In the embodiment, handwritten-page data is formed of a set of stroke data items as described above, and each stroke data item is formed of a plurality of coordinate data items. Further, the handwritten-page data may include time data associated with the time when a stroke is handwritten, and data indicative of the handwriting-pressure of the stroke. The XML file can manage the relationship between a plurality of elements, using a hierarchical document structure. Because of this, the XML file is useful for management of a plurality of stroke data items each including a plurality of coordinate data items. Yet further, since the XML file is text-base data, it can be changed in specifications more flexibly than a data-base file. Therefore, the use of the XML file can make it easy to, for example, add an attribute associated with stroke data or to add an attribute associated with coordinate data.

A description will now be given of the function of each module included in the handwritten-note application program 202.

The main controller 300 receives a sequence of coordinates corresponding to the locus of the movement of the stylus 100 from the touchscreen display 17 (more specifically, from, for example, digitizer 17C). The main controller 300 transmits, to the handwriting management module 312, for example, one stroke by one stroke, a plurality of coordinate data items (a plurality of point data items) corresponding to a plurality of points on the locus of the movement of the stylus. The handwriting management module 312 functions as a stroke processor configured to save, in the XML file, a plurality of stroke data items corresponding to a plurality of strokes handwritten in a certain handwritten page. More specifically, the handwriting management module 312 saves, in the XML file, a plurality of coordinate data items (a plurality of point data items) received from the main controller 300. After that, the handwriting management module 312 reads the plurality of coordinate data items (point data items) from the XML file, and transmits the read coordinate data items (point data items) to the drawing module 311. Since the handwriting management module 312 can immediately save, in the XML file, the plurality of coordinate data items (point data items) received from the main controller 300, the coordinate data items received from the main controller 300 may be firstly transmitted to the drawing module 311, and then can be saved in the XML file. Furthermore, the handwriting management module 312 can read a handwritten page (stroke data items) from an arbitrary XML file, and can transmit coordinate data items corresponding to each stroke data item to the drawing module 311.

The drawing module 311 is configured to draw (display), on a screen, a plurality of loci corresponding to the handwritten strokes. The drawing module 311 receives a plurality of coordinate data items from the handwriting management module 312, and draws (displays) loci corresponding to strokes based on the received coordinate data items. In this case, the drawing module 311 itself may draw (display) loci corresponding to strokes. Alternatively, the main controller 300 may receive a drawing result (loci), and display the loci corresponding to the strokes, based on the drawing result (loci).

Handwriting search module 313A and character recognition module 313B cooperate with the main controller 300 to serve as a generator configured to generate the above-mentioned handwriting-feature-amount data and character-string data corresponding to currently created or edited handwritten page as index data used to search for this handwritten page. More specifically, from a plurality of stroke data items stored in an XML file corresponding to a currently created or edited handwritten page, handwriting search module 313A generates plurality of handwriting feature amounts corresponding to the stroke data items, as index data (handwriting feature amount data). The index data (handwriting feature amount data) is used for searching the stroke data items by the handwriting search method. After that, handwriting search module 313A saves the generated handwriting feature amounts in feature-amount database 412A in association with the above-described identification data of the stroke data items (identification data of handwritten strokes).

The processing of the stroke data by handwriting search module 313A, that is, processing of generating handwriting-feature-amount data, is executed on non-processed stroke data, i.e., stroke data for which no handwriting feature amount is generated. Namely, handwriting search module 313A acquires each non-processed stroke data item from an XML file corresponding to a currently created or edited handwritten page. By processing each non-processed stroke data item, handwriting search module 313A calculates the handwriting feature amount of each non-processed stroke data item. As the handwriting feature amount of stroke data, arbitrary data indicative of the feature of stroke data (stroke) can be used. For instance, as the handwriting feature amount of a stroke, feature amount data, such as the shape of the stroke, the direction of writing of the stroke, and the inclination of the stroke, can be used.

Feature-amount database 412A is a database file for storing the handwriting-feature-amount data. A table in feature-amount database 412A stores a large number of identification data items (stroke IDs) assigned to a large number of stroke data items, and a large number of handwriting feature amounts corresponding to the large number of stroke data items. Further, in the table in feature-amount database 412A, the handwriting feature amount of a respective stroke data item may be associated not only with the identification data (stroke ID) of the respective stroke data item, but also with the identification data (page ID) of a handwritten page including the respective stroke data item.

Character recognition module 313B cooperates with the main controller 300 to generate a plurality of character codes corresponding to a plurality of stroke data items, as index data (character-string data). More specifically, character recognition module 313B generates the character codes from a plurality of stroke data items stored in an XML file corresponding to a currently created or edited handwritten page. The index data (character-string data) is used for searching the stroke data items by the text search method. After that, character recognition module 313B saves the generated character codes in character search database 412B in association with the above-described identification data of the stroke data items (identification data of the handwritten strokes). If one character is formed of two or more stroke data items, a character code corresponding to this character is saved in character search database 412B in association with the two or more stroke data items.

The processing (character recognition processing) of the stroke data by character recognition module 313B, that is, processing of generating a character code, is executed on non-processed stroke data, i.e., stroke data for which no character code is generated. Namely, character recognition module 313B acquires each non-processed stroke data item from an XML file corresponding to a currently created or edited handwritten page. By executing character recognition of each non-processed stroke data item, character recognition module 313B generates character codes corresponding to the respective non-processed stroke data items.

Character search database 412B is a database file for storing the character-string data. A table in character search database 412B stores a large number of identification data items (stroke IDs) assigned to a large number of stroke data items, and a large number of character codes corresponding to the large number of stroke data items. Further, in the table in character search database 412B, the character code of a respective stroke data item may be associated not only with the identification data (stroke ID) of the respective stroke data item, but also with the identification data (page ID) of a handwritten page including the respective stroke data item.

The database file of character search database 412B may differ from that of feature-amount database 412A. In this case, processing of saving the handwriting-feature-amount data and processing of saving the character-string data can be simultaneously executed.

Handwriting search module 313A functions not only as a generator for generating the handwriting-feature-amount data, but also as a search module for executing the above-mentioned handwriting search. Namely, handwriting search module 313A searches for stroke data corresponding to search-key stroke data, using the handwriting feature amount of the search-key stroke data and the handwriting-feature-amount data in feature-amount database 412A.

When handwriting search is executed, handwriting search module 313A receives, from the main controller 300, one or more stroke data corresponding to one or more strokes as a search key. After that, handwriting search module 313A searches for stroke data (handwritten portion) that matches the search key, using the handwriting-feature-amount data in feature-amount database 412A, and the handwriting feature amount (query feature amount) of the stroke data as the search key.

More specifically, handwriting search module 313A detects, from the handwriting-feature-amount data in feature-amount database 412A, a handwriting feature amount similar to the query feature amount, and returns, as the result of search to the main controller 300, stroke ID and page ID that correspond to the detected handwriting feature amount. In this case, feature-amount data whose degree of similarity with the query feature amount is not less than a reference value is acquired from feature-amount database 412A. As a method of calculating the degree of similarity, dynamic programming (DP) matching may be used.

The main controller 300 displays one or more handwritten pages each including stroke data (handwritten portion) corresponding to the above-mentioned search key, based on the search result (stroke ID and page ID) received from handwriting search module 313A. At this time, the main controller 300 may display the handwritten portion (hit word) within each of the one or more handwritten pages in an emphasized manner.

Character search module 313C functions as a search module for executing the above-described text search. Namely, character search module 313C searches for stroke data (handwritten portion) corresponding to text (one or more character codes) as a search key, using the text (one or more character codes) as the search key, and character-string data in character search database 412B.

When text search is executed, character search module 313C receives, from the main controller 300, one or more character codes corresponding to text as a search key. After that, character search module 313C searches for stroke data (handwritten portion) corresponding to the above-mentioned search key, using the character-string data in character search database 412B and the one or more character codes as the search key.

More specifically, character search module 313C detects, from the character-string data in character search database 412B, one or more character codes identical to one or more character codes as the search key, and returns, as the result of search to the main controller 300, one or more stroke IDs and page IDs that correspond to the detected one or more character codes.

The main controller 300 displays one or more handwritten pages each including stroke data (handwritten portion) corresponding to the text as the search key, based on the search result (one or more stroke IDs and page IDs) received from character search module 313C. At this time, the main controller 300 may display the handwritten portion (hit word) within each of the one or more handwritten pages in an emphasized manner.

Meta database 412C is a database for managing a plurality of metadata items corresponding to a plurality of handwritten pages, such as page-created time and date, page-updated time and date, page ID (UUID), page title, etc.

Although in the embodiment, both the handwriting-feature-amount data and the character-string data are saved in different database files, at least one of the handwriting-feature-amount data or the character-string data may be saved in one database file.

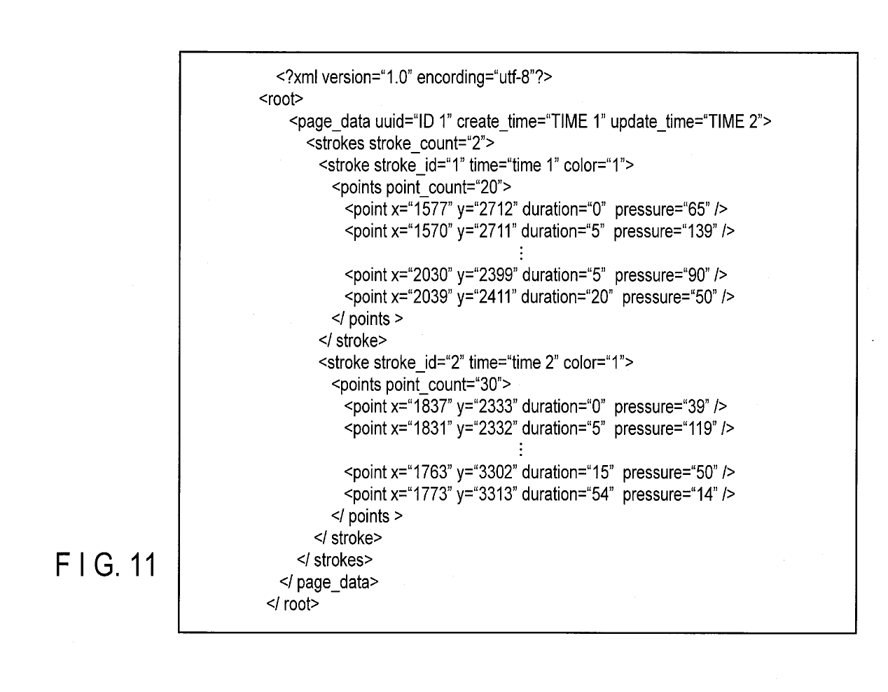

FIG. 11 shows the document structure of an XML file for managing multiple stroke data in a handwritten page.

An XML instance of the XML file includes a “root” element, a “page_data” element, a “strokes” element, “stroke” elements, “points” elements, and “point” elements. These elements define a hierarchical document structure. The “root” element is an element (node) as the initial point of all elements in the XML instance. The “page data” element is a child element of the “root” element.

The “page data” element includes three attributes, i.e., a “uuid” attribute, a “create_time” attribute and an “update_time” attribute. The attribute value “ID1” of the “uuid” attribute indicates the page ID of a handwritten page included in the XML file. The attribute value “TIME1” of the “create_time” attribute is time data associated with the time and date when the handwritten page was created. TIME1 may be an absolute time (year, month, date, hour, minute, second) indicating the creation time/date. The attribute value “TIME2” of the “create_time” attribute is time data associated with the time and date when the handwritten page was updated. TIME2 may be an absolute time (year, month, date, hour, minute, second) indicating the update time/date.

Further, the “page_data” element may include, for example, a “width” attribute indicative of the width of the handwritten page, a “height” attribute indicative of the height of the handwritten page, and a “title” attribute indicative of the title of the handwritten page.

The “strokes” element is a child element of the “page_data” element. The “strokes” element functions as an element (node) for grouping a plurality of “stroke” elements in the XML instance. The “strokes” element includes at least attribute, for example, a “stroke_count” attribute. The “stroke_count” attribute indicates the number (total number) of stroke data items currently included in the XML file. Whenever a new stroke data item is saved into the XML file, the attribute value of the “stroke_count” attribute is updated. FIG. 11 shows an example case where the attribute value of the “stroke_count” attribute is “2,” for simplifying the description.

The “stroke” elements are sibling elements which are in a sibling relationship. A certain “stroke” element corresponds to a certain stroke data item. A respective “stroke” element cooperates with a corresponding “points” element as a child element of the respective “stroke” element to function as an element (node) for grouping a plurality of “point” elements.

Each “stroke” element includes at least three attributes, i.e., a “stroke id” attribute, a “time” attribute and a “color” attribute. The “stroke id” attribute indicates the identification data (stroke ID) of a corresponding stroke data item. The “time” attribute is time data associated with the time when the corresponding stroke data was handwritten. The “time” attribute may be an absolute time (year, month, date, hour, minute, second) indicating the time when the corresponding stroke data item was handwritten. The “color” attribute indicates the color of a locus corresponding to the stroke data item.

Further, each “stroke” element may include, for example, a “width” attribute indicative of the width (line width) of the locus of a corresponding stroke data item, and a “type” attribute indicative of the line type of the locus of the corresponding stroke data item.

Each “points” element is child element of the corresponding “stroke” element. The “points” element functions as an element (node) for grouping a plurality of “point” elements which are child elements of the “points” element. Each “points” element includes at least one attribute, such as a “point_count” attribute. The “point_count” attribute indicates the total number of “point” elements included in the “points” element, i.e., the total number of coordinate data items.

A plurality of “point” elements grouped by a certain “points” element correspond to a plurality of coordinate data items included in a certain stroke. One “point” element corresponds to one coordinate data item (more specifically, corresponds to one pair of x coordinate and y coordinate).

Each “point” element may be an empty element that contains no content. Each “point” element includes, for example, four attributes, i.e., an “x” attribute, a “y” attribute, a “duration” attribute, and a “pressure” attribute. The “x” attribute indicates the x coordinate of the corresponding coordinate data (corresponding point). The “y” attribute indicates the y coordinate of the corresponding coordinate data (corresponding point). The “duration” attribute is time data indicative of the time interval from a time point at which the handwriting of the corresponding stroke is stared to a time point at which the corresponding coordinate data (corresponding point) is handwritten. The “pressure” attribute indicates handwriting pressure of the corresponding coordinate data (corresponding point).

As described above, in the XML file of the embodiment, each coordinate data item is managed as a “point” element with a tag. Further, a plurality of “point” elements corresponding to a plurality of coordinate data items in a single stroke are grouped by a “stroke” element including stroke ID indicative of stroke data that includes the coordinate data items.

Accordingly, all coordinate data items or any desired coordinate data item within a desired stroke can be easily extracted from the XML file without managing stroke data items in the form of a table.

Further, since the “stroke” elements each include time data, the time when each stroke was handwritten can be easily detected.

Yet further, since the XML file is a text-base file, data indicative of, for example, the type of an attribute associated with each element can be easily added. Also, the number of “point” elements that can be registered as child elements in the “stroke” element is not limited.

Each of handwriting search module 313A and character recognition module 313B can easily acquire non-processed stroke data items from the XML file, based on a plurality of “time” attribute (time data) items corresponding to a plurality of “stroke” elements. Namely, each of handwriting search module 313A and character recognition module 313B determines whether a stroke data item is a non-processed one, based on the “time” attribute of a corresponding “stroke” element, i.e., based on time data indicating the time when a stroke corresponding to the stroke data item was handwritten. For instance, a “stroke” element (stroke data) having time data indicative of a time later than the time of preceding handwriting-feature-amount/character-code generation processing (i.e., the time of lastly acquiring stroke data from the XML file) is determined to be non-processed stroke data. Each of handwriting search module 313A and character recognition module 313B may request time data of each stroke data item from the handwriting management module 312 to thereby receive therefrom the “time” attribute of each “stroke” element. Further, each of handwriting search module 313A and character recognition module 313B may determine non-processed stroke data and request the determined non-processed stroke data from the handwriting management module 312.

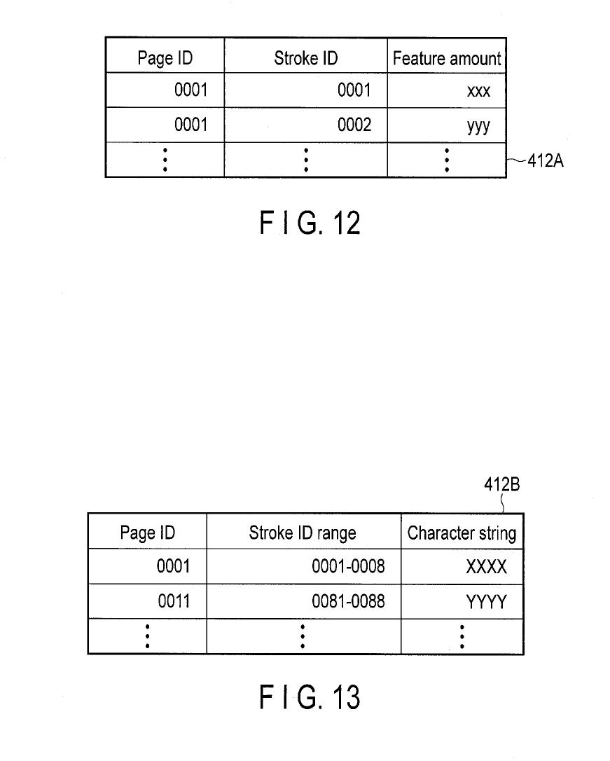

FIG. 12 shows a structure example of a handwriting-feature-amount management table stored in feature-amount database 412A. The handwriting-feature-amount management table includes a plurality of entries corresponding to a plurality of stroke data items. Each entry includes, for example, page ID, stroke ID and a feature amount (handwriting feature amount). In an entry corresponding to a certain stroke data item, the “page ID” indicates identification data allocated to a handwritten page on which the stroke data item is handwritten. The “stroke ID” indicates identification data allocated to the stroke data item. The “feature amount” (handwriting feature amount) indicates a feature amount (handwriting feature amount) calculated by analyzing the stroke data item. As the handwriting feature amount, feature-amount data indicative of the shape of each stroke can be used as described above.

Although the embodiment is directed to an example case where feature amounts corresponding to respective strokes are managed, feature amounts corresponding to respective handwritten objects (handwritten blocks), such as handwritten figures, handwritten tables, or handwritten symbols, may be managed. As the feature amount of a handwritten object, an arbitrary feature amount that can represent a feature of the handwritten object, such as an object shape, can be used. Further, the feature amount of the handwritten object may include data indicative of, for example, the order of writing of a plurality of strokes constituting the handwritten object.

FIG. 13 shows a structure example of a character-string data management table stored in character search database 412B. The character-string data management table includes a plurality of entries corresponding to a plurality of character blocks. Each entry includes, for example, “page ID,” a “stroke ID range,” and a “character string.” In an entry corresponding to a certain character block, the “page ID” indicates identification data allocated to a handwritten page on which the character block is handwritten. The “stroke ID range” indicates the range of identification data items allocated to strokes within the character block. The “character string” indicates a character string (character codes) corresponding to the character block. In association with the certain character block, a plurality of character code sets corresponding to a plurality of character candidates in the character block may be registered.

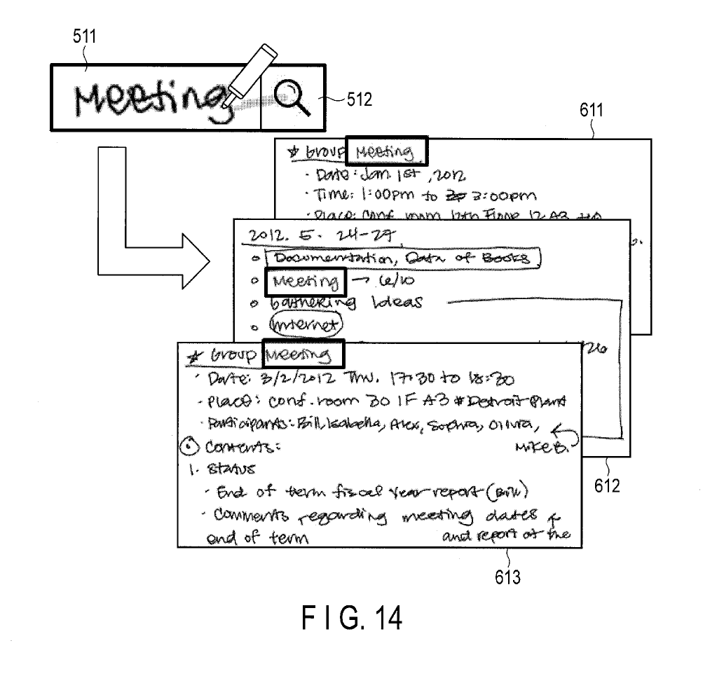

FIG. 14 shows the outline of handwritten document search. In the embodiment, it is assumed that a plurality of strokes corresponding to a handwritten character string “Meeting” have been handwritten in the search-key input area 511 by the stylus 100, and a handwriting search has been selected by a user.

Handwriting search module 313A receives one or more stroke data corresponding to one or more strokes as a search key from the main controller 300. Handwriting search module 313A calculates the handwritten feature amount (query feature amount) of the one or more stroke data. Subsequently, handwriting search module 313A refers to feature-amount database 412A to search for a handwritten page including a handwritten portion (stroke data) having a handwriting feature similar to the handwriting feature of the handwritten character string “Meeting.” Assume here that handwritten pages 611, 612 and 613 include handwritten portions having handwriting features similar to the handwriting feature of the handwritten character string “Meeting.” In this case, the main controller 300 displays the thumbnails of the handwritten pages 611, 612 and 613 on the screen, based on a search result received from handwriting search module 313A. At this time, the main controller 300 displays the hit word (handwritten character string “Meeting”) on the handwritten pages 611, 612 and 613 in an emphasized manner.

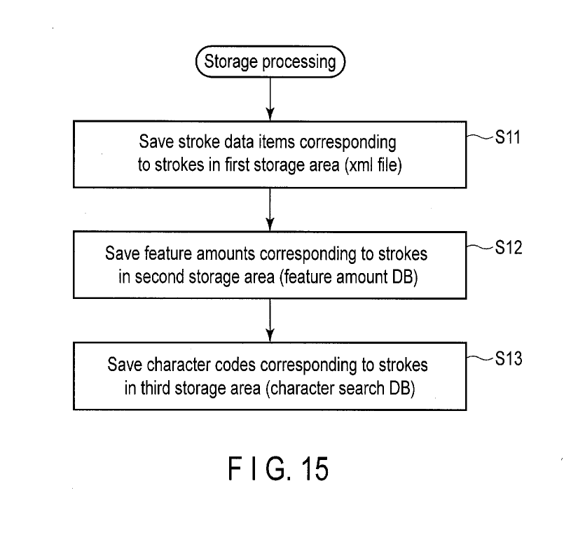

FIG. 15 is a flowchart showing a procedure of saving stroke data, handwriting-feature-amount data and character-string data, executed by the handwritten-note application program 202 during generating/editing a handwritten page.

The handwriting management module 312 saves, in a first storage area, stroke data corresponding to a plurality of strokes handwritten on a handwritten page as a generation/editing target (step S11). In this case, the handwriting management module 312 saves, in a first file (XML file) within the first storage area of a storage medium, stroke data corresponding to handwritten strokes input by handwriting in a format having a hierarchical document structure described in a markup language.

Handwriting search module 313A generates a plurality of handwriting feature amounts corresponding to the handwritten strokes by acquiring the stroke data from the XML file. Specially, handwriting search module 313A acquires non-processed strokes (a plurality of non-processed stroke data items) from the XML file during generating/editing a handwritten page. For instance, when the stylus 100 has separated from the screen, or when the stylus 100 is away from the screen for a predetermined period of time, handwriting search module 313A may acquire each non-processed stroke data item. Further, handwriting search module 313A generates a plurality of handwriting feature amounts corresponding to the acquired non-processed strokes, and saves the handwriting feature amounts corresponding to the acquired non-processed strokes in a second storage area different from the first storage area (step S12). At this time, handwriting search module 313A saves the plurality of handwriting feature amounts in a second file (feature-amount database file) different from the XML file in association with the identification data corresponding to the handwritten strokes (above-mentioned plurality of stroke IDs indicative of the stroke data items).

Character recognition module 3138 generates a plurality of character codes corresponding to the handwritten strokes by acquiring the stroke data from the XML file. Specially, character recognition module 313B acquires non-processed strokes (a plurality of non-processed stroke data items) from the XML file during generation/editing of the handwritten page. For instance, when the stylus 100 has separated from the screen, or when the stylus 100 is away from the screen for a predetermined period of time, character recognition module 313B may acquire non-processed stroke data. Further, character recognition module 313B generates a plurality of character codes corresponding to the acquired non-processed strokes, and saves the character codes corresponding to acquired non-processed strokes in a third storage area different from the second storage area (step S13). At this time, character recognition module 313B saves the plurality of character codes in a third file (character-search database file) different from the XML file and the feature-amount database file in association with the identification data corresponding to the handwritten strokes (above-mentioned plurality of stroke IDs indicative of the stroke data items).

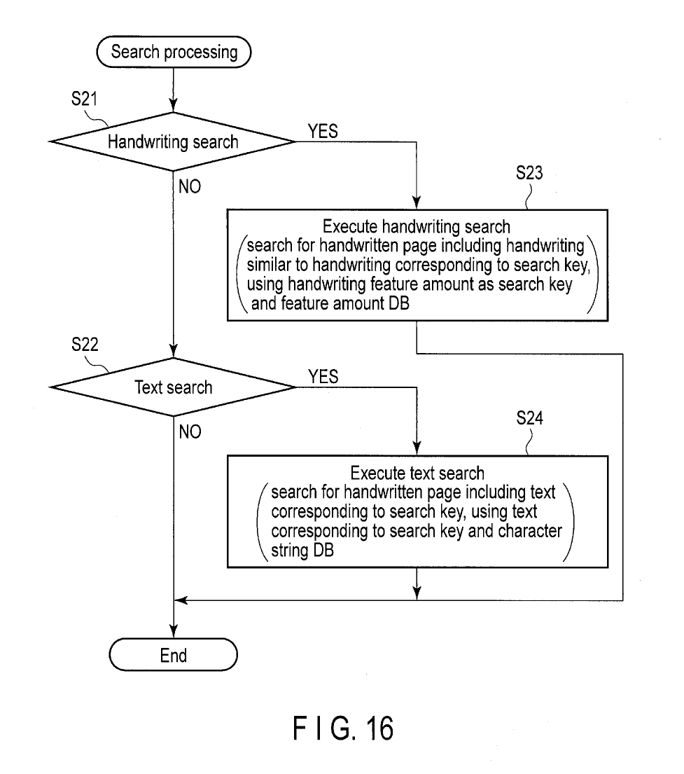

FIG. 16 is a flowchart showing a procedure of handwritten-document search processing executed by the handwritten-note application program 202.

If the user has selected a handwriting search scheme (Yes in step S21), the main controller 300 sends stroke data as a search key to handwriting search module 313A. Handwriting search module 313A executes handwriting search (step S23). At this time, handwriting search module 313A executes handwriting search using the handwriting feature amount of the stroke data as the search key and feature-amount data in feature-amount database 412A. Further, handwriting search module 313A searches for handwritten pages each including a handwritten data portion corresponding to the search key, i.e., handwritten pages each including stroke data having a handwriting feature similar to that of the stroke data as the search key.

In contrast, if the user has selected a text search scheme (Yes in step S22), the main controller 300 sends a character code as a search key to character search module 313C. Character search module 313C executes text search (character-string search) (step S24). At this time, character search module 313C executes text search using the character code as the search key and character search database 412B. Further, character search module 313C searches for handwritten pages each includes the character code corresponding to the search key.

As described above, in the embodiment, stroke data corresponding to handwritten strokes input by a handwriting is saved, in a first file, in a format having a hierarchical document structure described in a markup language. Further, at least one of (i) a plurality of handwriting feature amounts corresponding to handwritten strokes or (ii) a plurality of character codes corresponding to handwritten strokes is generated by acquiring the stroke data from the first file. And, at least one of (i) a handwriting feature amount corresponding to non-processed handwritten strokes or (ii) a character code corresponding to non-processed handwritten strokes is saved in a second file different from the first file.

Accordingly, even when handwriting-feature-amount data and/or character-string data corresponding to handwritten-page data are being generated and saved in the second file, such as a database file, processing of saving new stroke data in addition to the handwritten page data, and processing of drawing a stroke (locus) corresponding to the new stroke data can be executed promptly. In other words, while handwritten-page data is being generated or edited, handwriting-feature-amount data and/or character-string data corresponding to the handwritten-page data can be saved.

Further, stroke data corresponding to handwritten strokes can be easily managed using, as a storage form for the stroke data, a hierarchical document structure format described in the markup language.

Yet further, the use of the hierarchical document structure format described in the markup language as the storage format for the stroke data items each including coordinate data items facilitates the management of the stroke data items.

Also, in the second file, at least a handwriting feature amount corresponding to one or more stroke data items, or a character code corresponding to one or more stroke data items, is associated with identification data corresponding to the one or more stroke data items. Thus, the use of the second file enables stroke data having a handwriting feature amount similar to that of a stroke as a search key, or stroke data corresponding to a character code as a search key, to be efficiently searched for. In addition, the hierarchical document structure of the first file includes at least a plurality of first elements that correspond to a plurality of coordinate data items included in one stroke data item, and a second element that includes identification data indicative of the one stroke data item, and is used to group the first elements. Accordingly, processing of, for example, acquiring target stroke data from the first file can be executed efficiently.

Since various types of processing for handwritten-document data (handwritten page) of the embodiment can be realized by a computer program, the same advantage as the embodiment can be easily obtained simply by installing the computer program into a general computer through a computer-readable storage medium, and executing the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
execute a process of saving, in a first file, stroke data corresponding to handwritten strokes input by a handwriting in a format having a hierarchical document structure described in a markup language; and
execute a process of generating at least one of (i) a plurality of handwriting feature amounts corresponding to handwritten strokes or (ii) a plurality of character codes corresponding to handwritten strokes by acquiring the stroke data from the first file,
wherein at least one of (i) a handwriting feature amount corresponding to non-processed handwritten strokes or (ii) a character code corresponding to non-processed handwritten strokes is saved in a second file different from the first file.

2. The electronic device of claim 1, wherein
the hierarchical document structure includes time data associated with times when handwritten strokes are handwritten, and
the circuitry is configured to acquire non-processed stroke data from the first file, based on the time data.

3. The electronic device of claim 1, wherein
in the second file, at least one of a handwriting feature amount or a character code is associated with identification data corresponding to the handwritten strokes,
in the first file, the hierarchical document structure comprises:
a plurality of first elements corresponding to a plurality of coordinate data included in one handwritten stroke; and
a second element for grouping the plurality of first elements, the second element including identification data corresponding to the one handwritten stroke.

4. The electronic device of claim 3, wherein the second element includes time data associated with a time when the one handwritten stroke is handwritten.

5. The electronic device of claim 4, wherein the circuitry is configured to determine whether the one handwritten stroke corresponding to the second element is a non-processed handwritten stroke, based on the time data of the second element.

6. The electronic device of claim 1, wherein
the circuitry is further configured to execute at least one of handwriting search or text search,
the handwriting search is executed to search for stroke data corresponding to a first handwritten stroke as a search key, by using a handwriting feature amount of the first handwritten stroke and a plurality of handwriting feature amounts within the second file, and
the text search is executed to search for stroke data corresponding to a first character code as a search key, by using the first character code and a plurality of character codes within the second file.

7. The electronic device of claim 1, wherein
the circuitry is configured to:
execute a process for saving, in the second file, a handwriting feature amount corresponding to the non-processed handwritten strokes in association with identification data corresponding to the handwritten strokes; and
execute a process for saving, in a third file different from the second file, a character code corresponding to the non-processed handwritten strokes in association with the identification data corresponding to the non-processed handwritten strokes.

8. A method comprising:
saving, in a first file, stroke data corresponding to handwritten strokes input by a handwriting in a format having a hierarchical document structure described in a markup language; and
generating at least one of (i) a plurality of handwriting feature amounts corresponding to handwritten strokes or (ii) a plurality of character codes corresponding to handwritten strokes by acquiring the stroke data from the first file,
wherein at least one of (i) a handwriting feature amount corresponding to non-processed handwritten strokes or (ii) a character code corresponding to non-processed handwritten strokes is saved in a second file different from the first file.

9. A computer-readable, non-transitory storage medium having stored thereon a computer program which is executable by a computer, the computer program controlling the computer to execute functions of:
saving, in a first file, stroke data corresponding to handwritten strokes input by a handwriting in a format having a hierarchical document structure described in a markup language; and
generating at least one of (i) a plurality of handwriting feature amounts corresponding to handwritten strokes or (ii) a plurality of character codes corresponding to handwritten strokes by acquiring the stroke data from the first file,
wherein at least one of (i) a handwriting feature amount corresponding to non-processed handwritten strokes or (ii) a character code corresponding to non-processed handwritten strokes is saved in a second file different from the first file.
